(19) United States
(12) Patent Application Publication
(10) Pub. No.: US 2018/0099660 A1
(43) Pub. Date: Apr. 12, 2018

(54) System And Method For Control Of A Towed Trailer

(71) Applicant: GM GLOBAL TECHNOLOGY OPERATIONS LLC, Detroit, MI (US)

(72) Inventors: Norman J. Weigert, Whitby (CA); Grant L. Meade, Whitby (CA); Vyacheslav Berezin, Newmarket (CA)

(21) Appl. No.: 15/286,658

(22) Filed: Oct. 6, 2016

(51) Int. Cl. B60W 30/06; B62D 13/06; B60W 10/18; B60W 10/20

(52) U.S. Cl. CPC B60W 30/06; B62D 13/06; B60W 50/14; B60W 10/20; B60W 10/18

(57) ABSTRACT

A vehicle includes a steering input device having a nominal setting, a sensor configured to detect a presence of a trailer towed by the vehicle, and a controller in electronic communication with the steering input device and the sensor. The controller is configured to communicate with a towed trailer. The controller is programmed to, in response to the sensor detecting a presence of a towed trailer and the steering input device being within a predetermined range of the nominal setting, automatically communicate a braking command to the towed trailer to maintain a nominal articulation angle between the trailer and the vehicle.

### TECHNICAL FIELD

The present disclosure relates to motorized vehicles configured to tow loads such as trailers. More particularly, the present disclosure relates to the handling of such motorized vehicles and towed loads.

### INTRODUCTION

Many motorized vehicles are designed to accommodate the towing or trailering of various loads, such as campers, boats, and sometimes other motorized vehicles. Generally, the towed load is coupled to the motorized vehicle by a pivotable attachment such as a ball hitch. Due to the pivotable attachment, the towed load may become misaligned with the motorized vehicle during various maneuvers. Vehicle operators may find it challenging to control the motorized vehicle in such conditions.

### SUMMARY

A vehicle according to the present disclosure includes a steering input device having a nominal setting, a sensor configured to detect a presence of a trailer towed by the vehicle, and a controller in electronic communication with the steering input device and the sensor. The controller is configured to communicate with a towed trailer. The controller is programmed to, in response to the sensor detecting a presence of a towed trailer and the steering input device being within a predetermined range of the nominal setting, automatically communicate a braking command to the towed trailer to maintain a nominal articulation angle between the trailer and the vehicle.

According to an exemplary embodiment, the braking command includes a first braking command for a driver-side trailer brake and a second braking command for a passenger-side trailer brake. In such embodiments, the controller may be programmed to determine the first braking command and second braking command to provide differential braking to maintain the nominal articulation angle.

According to an exemplary embodiment, the controller is programmed to automatically communicate the braking command in further response to a current articulation angle being within a predetermined range of the nominal articulation angle.

According to an exemplary embodiment, the vehicle additionally includes a transmission, and the controller is programmed to automatically communicate the braking command in further response to the transmission being in a REVERSE gear.

According to an exemplary embodiment, the controller is configured to communicate with a towed trailer via a communication harness.

According to an exemplary embodiment, the vehicle additionally includes an operator interface in electronic communication with the controller. In such embodiments, the controller is further programmed to, in response to communicating a braking command to the towed trailer, provide an operator indicator via the operator interface.

A method of controlling a vehicle according to the present disclosure includes providing a vehicle with a transmission having a REVERSE gear, a steering input device having a nominal setting, and a pivotable hitch interface for towing a trailer. The method additionally includes automatically controlling a trailer system to provide a corrective steering influence toward a nominal articulation angle. The automatic control of the trailer system is in response to detecting a trailer being towed by the vehicle, detecting an articulation angle between the vehicle and the trailer being different from the nominal articulation angle, detecting the transmission being in the REVERSE gear, and detecting the steering input device being within a threshold range of the nominal setting.

According to an exemplary embodiment, the trailer system includes a first trailer wheel brake and a second trailer wheel brake. In such an embodiment, automatically controlling the trailer includes automatically controlling the first trailer wheel brake to provide a first braking torque with a first magnitude and automatically controlling the second trailer wheel brake to provide a second braking torque with a second magnitude. The first magnitude is different from the second magnitude to provide differential braking.

According to an exemplary embodiment, the automatic control of the trailer system is in further response to the detected articulation angle being less than a threshold articulation angle.

According to an exemplary embodiment, the method additionally includes providing the vehicle with a controller in communication with the trailer system. In such embodiments, the automatic control of the trailer system is performed via the controller. In such embodiments, the controller may be configured to automatically control the trailer system via a communication harness.

According to an exemplary embodiment, the method additionally includes providing an operator indicator via an operator interface indicative of the automatic control of the trailer system.

A system for a vehicle includes a first sensor configured to detect a steering input device position, a second sensor configured to detect a gear ratio of a vehicle transmission, a third sensor configured to detect an articulation angle between the vehicle and a towed trailer, and a controller. The controller is programmed to receive a first signal from the first sensor indicating the steering input device being within a predetermined range of a nominal setting, receive a second signal from the second sensor indicating the transmission being in a REVERSE gear, and receive a third signal from the third sensor indicating the articulation angle between different from a nominal articulation angle. The controller is also programmed to, in response to the first signal, second signal, and third signal, automatically generate a corrective steering command and communicate the corrective steering command to a trailer system.

According to an exemplary embodiment, the trailer system includes a driver-side trailer brake and a passenger-side trailer brake. In such an embodiment, the corrective steering command includes a first braking command for the driver-side trailer brake and a second braking command for the passenger-side trailer brake. The first braking command and second braking command have different magnitudes to provide differential braking.

According to an exemplary embodiment, the controller is programmed to automatically generate the corrective steering command in further response to the articulation angle being within a predetermined range of the nominal articulation angle.

According to an exemplary embodiment, the controller is configured to communicate the corrective steering command via a communication harness.

According to an exemplary embodiment, the system additionally includes an operator interface in electronic communication with the controller. In such embodiments, the controller is further programmed to, in response to communicating the corrective steering command to a trailer system, provide an operator indicator via the operator interface.

Embodiments according to the present disclosure provide a number of advantages. For example, the present disclosure provides a system and method for improved handling of a towed trailer when the towing vehicle is in reverse. Moreover, systems and methods according to the present disclosure provide such benefits without necessitating additional hardware or components to the vehicle or trailer.

The above advantage and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic representation of an embodiment of a vehicle and trailer according to the present disclosure;

FIG. 2 is a second representation of an embodiment of a vehicle and trailer according to the present disclosure;

FIG. 3 is a flowchart illustrating a method of controlling a vehicle and trailer according to the present disclosure; and

FIG. 4 is a logic diagram illustrating a method of controlling a vehicle and trailer according to the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the exemplary aspects of the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

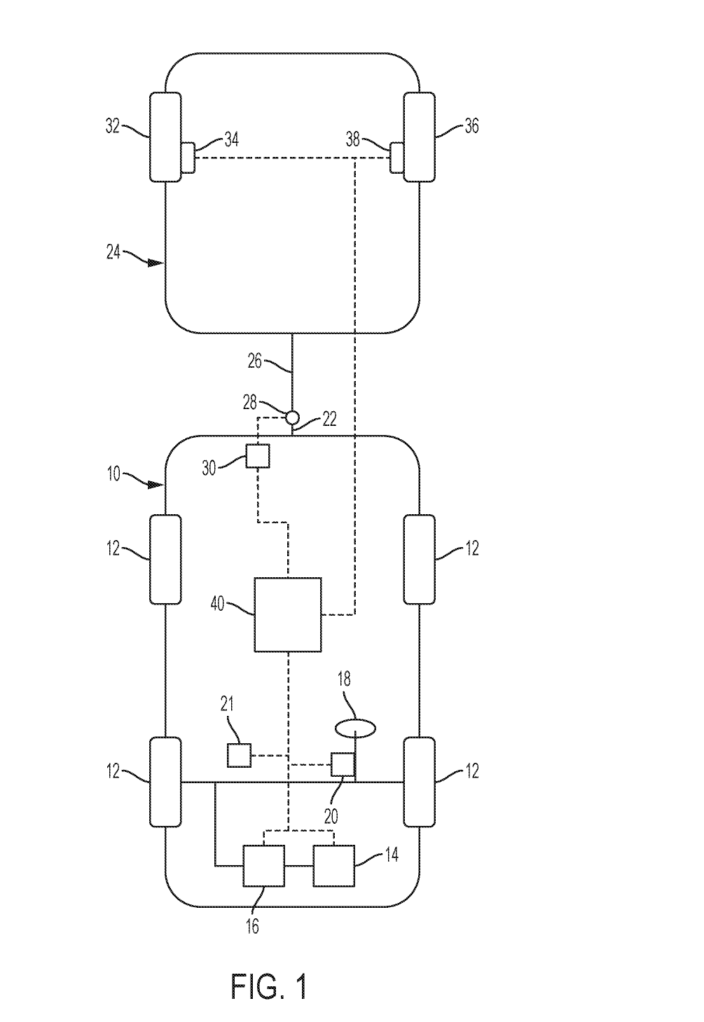

Referring now to FIG. 1, an exemplary vehicle 10 according to the present disclosure is illustrated schematically. The vehicle 10 includes a plurality of traction wheels 12, a propulsion system 14, and a transmission 16 configured to transmit power from the propulsion system 14 to the wheels 12 according to selectable speed ratios. According to various embodiments, the propulsion system 14 may include an internal combustion engine, a fuel cell, an electric traction motor, a hybrid drive system, or other appropriate propulsion system, while the transmission 16 may include a step-ratio automatic transmission, a continuously-variable transmission, or other appropriate transmission.

The vehicle 10 additionally includes a steering input device 18 by which an operator may control steering of the traction wheels 12. While depicted as a conventional steering wheel, in other considered embodiments the steering input device 18 may include other input devices such as a joystick. At least one sensor 20 is provided to detect a position of the steering input device 18. The steering input device 18 has a nominal or neutral position, e.g. a zero-degree rotation position on a steering wheel. The nominal position corresponds to the traction wheels 12 being oriented generally parallel to the centerline of the vehicle 10, i.e. positioned for straight-ahead driving.

The vehicle 10 further includes an operator interface 21. The operator interface 21 is configured to present information to a vehicle operator, e.g. via a visual or audiovisual display. The operator interface 21 may also be configured to receive input from a vehicle operator. In an exemplary embodiment the operator interface 21 includes a multifunction display arranged in a vehicle dash area. However, in other considered embodiments, the operator interface 21 may be provided via a mobile device usable by an operator.

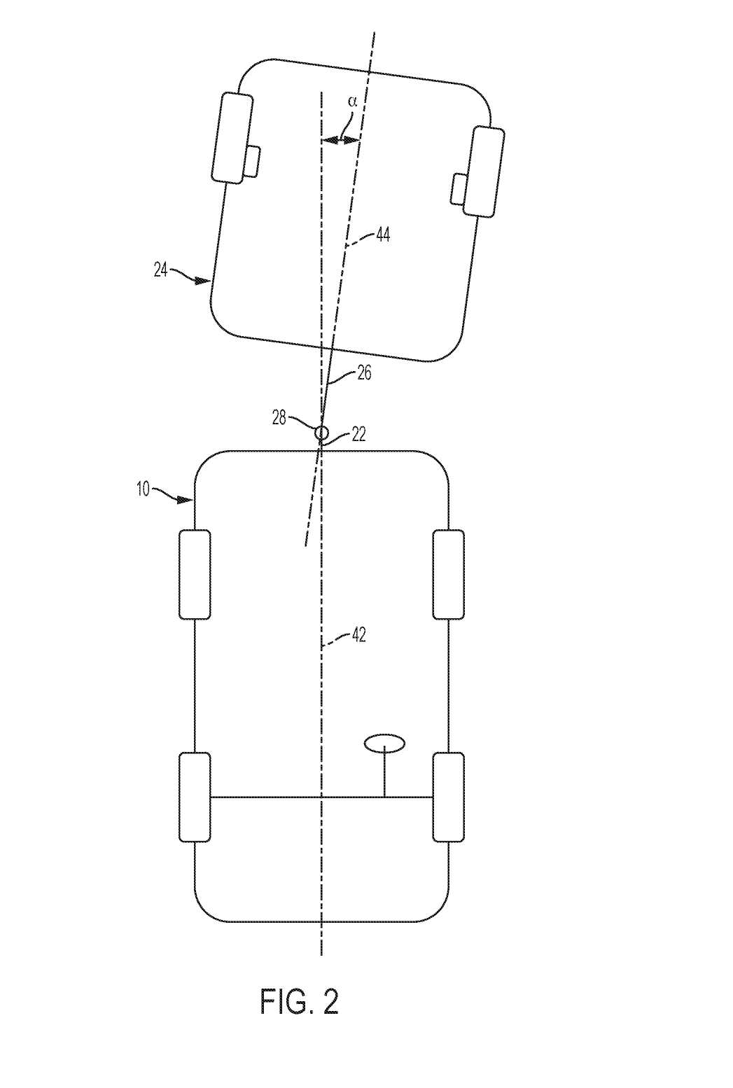

The vehicle 10 is provided with a hitch 22 capable of towing a trailer 24. The trailer 24 includes a tongue 26 coupled to the hitch 22 at a pivotable hitch interface 28, e.g. a ball. The hitch interface 28 permits the tongue 26 to pivot relative to the hitch 22, e.g. during vehicle turns. An articulation angle is defined between a central axis of the vehicle 10 and a central axis of the trailer 24, as will be discussed in further detail with respect to FIG. 2 below. At least one trailer sensor 30 is arranged to determine a presence or absence of a trailer and to detect the articulation angle. In various embodiments, the trailer sensor 30 may include a hardware sensor such as a rotary encoder, an optical sensor for determining trailer presence and articulation angle based on captured images, other sensors as appropriate, or a combination of multiple sensors.

The trailer 24 is provided with a first trailer wheel 32 having a first trailer wheel brake 34 and a second trailer wheel 36 having a second trailer wheel brake 38. In other embodiments within the scope of the present disclosure, additional trailer wheels may be provided, e.g. on additional axles.

The vehicle 12 is provided with a controller 40. The engine 14, transmission 16, steering sensor 20, operator interface 21, and trailer sensor 30 are all in communication with or under the control of the controller 40. While depicted as a single controller, the controller 40 may include a plurality of separate controllers collectively referred to as a “controller.” The controller 40 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The first trailer wheel brake 34 and the second trailer wheel brake 38 are also in communication with or under the control of the controller 40. According to various embodiments, a direct electrical connection may be provided, e.g. via a wiring harness, or a wireless connection may be provided, e.g. via 802.11 Wi-Fi. As will be discussed in further detail below, the first trailer wheel brake 34 and the second trailer wheel brake 38 may be engaged to provide braking torque to the first trailer wheel 32 and the second trailer wheel 36, respectively, in response to one or more braking commands from the controller 40.

Referring now to FIG. 2, an articulation angle α is illustrated between the vehicle 10 and the trailer 24. The articulation angle α is defined between a vehicle central axis 42 and a trailer central axis 44. In this embodiment, the vehicle central axis 42 falls in line with the hitch 22 and the trailer central axis 44 falls in line with the tongue 26. However, in other considered embodiments, the hitch 22 or tongue 26 may be arranged in different locations or with different configurations. Likewise, in some embodiments contemplated within the scope of the present disclosure, the trailer may not have a traditional tongue, e.g. a so-called gooseneck trailer.

When the vehicle 10 and trailer 24 are in-line, e.g. with the vehicle central axis 42 and the trailer central axis 44 being coincident, the articulation angle α is zero. As the hitch 22 pivots relative to the tongue 26 about the hitch interface 28, e.g. during a vehicle turn, the articulation angle α deviates from zero.

Maneuvering a vehicle with a trailer in reverse may be challenging for many operators. Reversing in a straight line may be particularly challenging. A small deviation from zero articulation angle may quickly increase if not corrected. This behavior is referred to as “jack-knifing”.

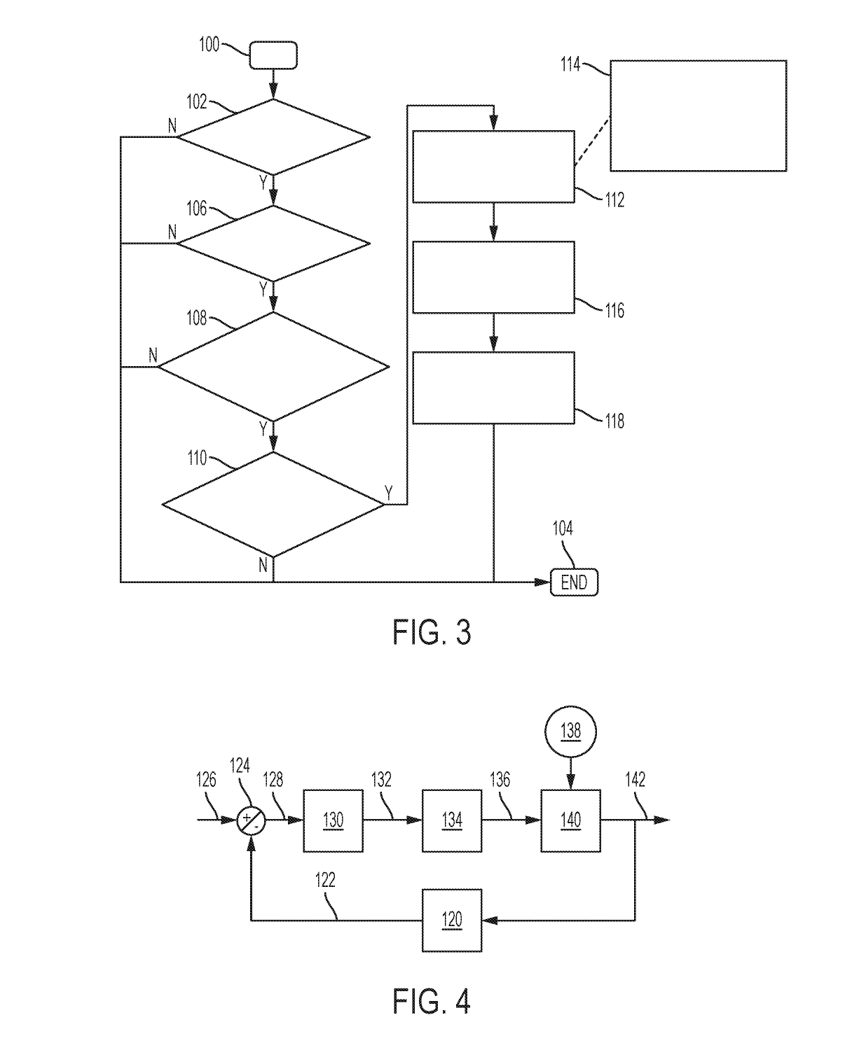

Referring now to FIG. 3, a flowchart illustrates a method of controlling a vehicle and trailer according to the present disclosure. The algorithm starts at block 100.

Proceeding to operation 102, a determination is made of whether a trailer is being towed. This determination may be made, for example, in response to a reading from the trailer sensor 30. If the determination is negative, the algorithm ends at block 104. If the determination is positive, control proceeds to operation 106.

Proceeding to operation 106, a determination is made of whether the vehicle transmission is in a REVERSE gear. If the determination is negative, the algorithm ends at block 104. If the determination is positive, control proceeds to operation 108.

Proceeding to operation 108, a determination is made of whether the steering input device is within a threshold distance of a nominal position. In embodiments where the steering input device includes a steering wheel, the threshold distance may be an angular rotation threshold of, for example, ±2 degrees from the nominal position. If the determination is negative, the algorithm ends at block 104. If the determination is positive, control proceeds to operation 110.

Proceeding to operation 110, a determination is made of whether the articulation angle is within a threshold angular position of a nominal position, e.g. zero degrees. If the determination is negative, the algorithm ends at block 104. If the determination is positive, control proceeds to block 112.

Proceeding to block 112, a differential braking command is generated to maintain the nominal articulation angle. The differential braking command may include a first braking command for the first trailer wheel brake and a second braking command for the second trailer wheel brake, as represented by block 114. The differential braking command is calculated such that a differential braking torque between the first trailer wheel and the second trailer wheel urges the articulation angle toward zero.

The trailer brakes are controlled according to the differential braking command, as represented at block 116. In the exemplary embodiment of FIG. 1, this may be performed by the controller 40 controlling the first trailer wheel brake 34 according to the first braking command and controlling the second trailer wheel brake 38 according to the second braking command.

Feedback is then provided via an operator interface, as represented at block 118. The feedback may include an audio cue, visual indicator, haptic feedback, other appropriate feedback indicative of operation of the differential braking algorithm, or a combination thereof. The algorithm ends at block 104.

Referring now to FIG. 4, a logic diagram illustrates a method of controlling a vehicle and trailer according to the present disclosure. As represented at block 120, a trailer sensor measures an articulation angle and outputs a measured articulation angle 122. At operation 124, a difference is calculated between a nominal articulation angle 126, e.g. 0 degrees, and the measured articulation angle 122.

The calculated difference 128 is output to a trailer braking algorithm 130. As discussed above, the trailer braking algorithm is configured to generate a differential braking command, e.g a first braking command for a first trailer wheel brake and a second braking command for a second trailer wheel brake.

The trailer braking algorithm 130 outputs a control signal 132. The control signal 132 may include one or more braking commands, e.g. a first braking command for a first trailer wheel brake and a second braking command for a second trailer wheel brake.

The control signal 132 is output to actuators 134. In an exemplary embodiment, the actuators 134 are associated with the first trailer wheel brake and the second trailer wheel brake. The actuators apply differential braking torque by controlling the first trailer wheel brake according to the first braking command and controlling the second trailer wheel brake according to the second braking command.

The differential braking torque applied by the actuators 134 result in a steering torque 136. The steering torque 136, in conjunction with environmental effects 138 such as road surface, wind, and tire pressure disturbances, impose a net torque on a hitch interface 140, in turn resulting in a new articulation angle 142. The articulation angle 142 may be measured by the trailer sensor at block 120, resulting in a feedback system.

In some considered embodiments, the trailer may include additional wheels having wheel brakes, e.g. coupled to an additional axle. In such embodiments, the above-described algorithm may be modified to control a greater number of wheel brakes to produce the desired steering correction. This may include controlling all wheel brakes of the trailer or a subset of wheel brakes as appropriate.

In other considered embodiments, other trailer systems may be used to provide a steering correction in place of, or in addition to, differential braking as discussed above. As a non-limiting example, a trailer may be provided with a steerable axle. In such an example, the steerable axle of the trailer may be controlled to provide a steering correction toward zero articulation angle in response to the steering input device being within the threshold distance of the nominal position.

As may be seen, the present disclosure provides a system and method for improved handling of a towed trailer when the towing vehicle is in reverse relative to conventional trailers, which apply trailer brakes in unison. Moreover, systems and methods according to the present disclosure provide such benefits without necessitating additional hardware or components to the vehicle or trailer.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a steering input device having a nominal setting;
a sensor configured to detect a presence of a trailer towed by the vehicle; and
a controller in electronic communication with the steering input device and the sensor and configured to communicate with a towed trailer, the controller being programmed to, in response to the sensor detecting a presence of a towed trailer and the steering input device being within a predetermined range of the nominal setting, automatically communicate a braking command to the towed trailer to maintain a nominal articulation angle between the trailer and the vehicle.

2. The vehicle of claim 1, wherein the braking command includes a first braking command for a driver-side trailer brake and a second braking command for a passenger-side trailer brake.

3. The vehicle of claim 2, wherein the controller is programmed to determine the first braking command and second braking command to provide differential braking to maintain the nominal articulation angle.

4. The vehicle of claim 1, wherein the controller is programmed to automatically communicate the braking command in further response to a current articulation angle being within a predetermined range of the nominal articulation angle.

5. The vehicle of claim 1, further comprising a transmission, wherein the controller is programmed to automatically communicate the braking command in further response to the transmission being in a REVERSE gear.

6. The vehicle of claim 1, wherein the controller is configured to communicate with a towed trailer via a communication harness.

7. The vehicle of claim 1, further comprising an operator interface in electronic communication with the controller, wherein the controller is further programmed to, in response to communicating a braking command to the towed trailer, provide an operator indicator via the operator interface.

8. A method of controlling a vehicle, comprising:
providing a vehicle with a transmission having a REVERSE gear, a steering input device having a nominal setting, and a pivotable hitch interface for towing a trailer;
in response to detecting a trailer being towed by the vehicle, detecting an articulation angle between the vehicle and the trailer being different from a nominal articulation angle, detecting the transmission being in the REVERSE gear, and detecting the steering input device being within a threshold range of the nominal setting, automatically controlling a trailer system to provide a corrective steering influence toward the nominal articulation angle.

9. The method of claim 8, wherein the trailer system comprises a first trailer wheel brake and a second trailer wheel brake, and wherein automatically controlling the trailer includes automatically controlling the first trailer wheel brake to provide a first braking torque with a first magnitude and automatically controlling the second trailer wheel brake to provide a second braking torque with a second magnitude, the first magnitude being different from the second magnitude to provide differential braking.

10. The method of claim 8, wherein the automatically controlling the trailer system is in further response to the detected articulation angle being less than a threshold articulation angle.

11. The method of claim 8, further comprising providing the vehicle with a controller in communication with the trailer system, wherein the automatic control of the trailer system is performed via the controller.

12. The method of claim 11, wherein the controller is configured to automatically control the trailer system via a communication harness.

13. The method of claim 8, further comprising providing an operator indicator via an operator interface indicative of the automatic control of the trailer system.

14. A system for a vehicle, comprising:
a first sensor configured to detect a steering input device position;
a second sensor configured to detect a gear ratio of a vehicle transmission;
a third sensor configured to detect an articulation angle between the vehicle and a towed trailer; and
a controller being programmed to receive a first signal from the first sensor indicating the steering input device being within a predetermined range of a nominal setting, receive a second signal from the second sensor indicating the transmission being in a REVERSE gear, receive a third signal from the third sensor indicating the articulation angle between different from a nominal articulation angle, and, in response to the first signal, second signal, and third signal, automatically generate a corrective steering command and communicate the corrective steering command to a trailer system.

15. The system of claim 14, wherein the trailer system includes a driver-side trailer brake and a passenger-side trailer brake, and wherein the corrective steering command includes a first braking command for the driver-side trailer brake and a second braking command for the passenger-side trailer brake, the first braking command and second braking command having different magnitudes to provide differential braking.

16. The system of claim 14, wherein the controller is programmed to automatically generate the corrective steering command in further response to the articulation angle being within a predetermined range of the nominal articulation angle.

17. The system of claim 14, wherein the controller is configured to communicate the corrective steering command via a communication harness.

18. The system of claim 14, further comprising an operator interface in electronic communication with the controller, wherein the controller is further programmed to, in response to communicating the corrective steering command to a trailer system, provide an operator indicator via the operator interface.
